(19) United States
(12) Patent Application Publication
(10) Pub. No.: US 2026/0024858 A1
(43) Pub. Date: Jan. 22, 2026

(54) BATTERY PACK HOUSING

(71) Applicant: GM GLOBAL TECHNOLOGY OPERATIONS LLC, Detroit, MI (US)

(72) Inventors: Naveen Kumar N, Bangalore (IN); Erich GERNAND, Flint, MI (US); Ryan Patrick HICKEY, Austin, TX (US); Michael FLECK, Rochester Hills, MI (US)

(21) Appl. No.: 18/779,298

(22) Filed: Jul. 22, 2024

(51) Int. Cl. H01M 50/24; B60L 50/64; H01M 50/224; H01M 50/242; H01M 50/249; H01M 50/262; H01M 50/271; H01M 50/30

(52) U.S. Cl. CPC H01M 50/24; H01M 50/224; H01M 50/242; H01M 50/249; H01M 50/262; H01M 50/271; H01M 50/30; B60L 50/64; H01M 2220/20

(57) ABSTRACT

A battery pack housing including a tray having an outer tray perimeter; a deflector plate mounted to the tray along the outer tray perimeter; a cover; and a seal between the cover and the deflector plate. The cover is mounted over the deflector plate and the tray such that the deflector plate is between the tray and the cover, and the seal is pressed against the deflector plate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a battery pack housing.

Electric vehicles include batteries packed together in a housing. The housing typically includes a tray and a cover. The cover is secured to the tray with a seal. The seal prevents contaminants from entering the housing. The seal also contains within the housing any gases that may be released from the batteries during a thermal event.

### SUMMARY

The present disclosure includes, in various features, a battery pack housing having: a tray including an outer tray perimeter; a deflector plate mounted to the tray along the outer tray perimeter; a cover; and a seal between the cover and the deflector plate. The cover is mounted over the deflector plate and the tray such that the deflector plate is between the tray and the cover, and the seal is pressed against the deflector plate.

In further features, the deflector plate is welded to the tray.

In further features, foam is between the deflector plate and the tray, the foam configured to dampen noise and vibrations.

In further features, the foam is opposite to the seal.

In further features, the seal is in cooperation with the cover.

In further features, the tray is metallic and the cover is made of a composite material.

In further features, a fastener is in cooperation with the tray, the deflector plate, and the cover.

In further features, the cover defines an aperture through which the fastener extends, the aperture is vertically offset from the seal; and the cover includes a stepped surface between the seal and the aperture.

In further features, the deflector plate includes a curved surface at an inner end thereof extending towards the cover.

In further features, the curved surface is configured to provide a barrier between the seal and emissions released from a battery within the battery pack housing during a thermal event.

The present disclosure also includes, in various features, a battery pack housing including: a tray including an outer tray perimeter; a deflector plate mounted to the tray along the outer tray perimeter, the deflector plate including a flange at an inner end of the deflector plate, the flange extending away from the tray; a cover defining a receptacle at an inner surface of the cover, the receptacle extending about an outer cover perimeter of the cover; and a seal that is press-fit into the receptacle and pressed against the deflector plate. The cover is mounted over the deflector plate and the tray such that the deflector plate is between the tray and the cover, the flange of the deflector plate extends towards the cover, and the flange provides a barrier between an interior of the battery pack housing and the seal.

In further features, the deflector plate is welded to the tray.

In further features, foam is between the deflector plate and the tray, the foam configured to dampen noise and vibrations.

In further features, the foam is opposite to the seal.

In further features, the flange is curved towards the cover.

In further features, a fastener is in cooperation with the tray, the deflector plate, and the cover.

In further features, the cover defines an aperture through which the fastener extends, the aperture is vertically offset from the receptacle; and the cover includes a stepped surface between the aperture and the receptacle.

The present disclosure also provides for, in various features, a battery pack housing including: a tray including an outer tray perimeter; a deflector plate welded to the tray along the outer tray perimeter, the deflector plate including a curved surface at an inner end of the deflector plate, the curved surface extending away from the tray; a vibration damper between the deflector plate and the tray; a cover defining a receptacle at an inner surface of the cover, the receptacle extending about an outer cover perimeter of the cover; a seal that is press-fit into the receptacle and pressed against the deflector plate; and a fastener extending through the tray, the deflector plate, and the cover to connect the cover to the tray with the deflector plate between the cover and the tray, and to press the seal against the deflector plate. The curved surface of the deflector plate extends towards the cover and provides a barrier between an interior of the battery pack housing and the seal.

In further features, the vibration damper is opposite to the seal.

In further features, the cover is spaced apart from the deflector plate and the tray.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a battery pack housing in accordance with the present disclosure, and an exemplary vehicle frame to which the battery pack housing may be mounted;

FIG. 2 is a perspective view of a corner of the battery pack housing of FIG. 1; and

FIG. 3 is a cross-sectional view taken along line 3-3 of FIG. 2.

In the drawings, reference numbers may be reused to identify similar and/or identical elements.

### DETAILED DESCRIPTION

The present disclosure includes a battery pack housing, such as for an electric vehicle or hybrid vehicle. The battery pack housing of the present disclosure may also be configured for non-vehicular use as well. The battery pack housing includes a tray and a cover, which is sealed to the tray with a seal. Packs of batteries are sealed within the housing.

Servicing a battery pack presents various challenges. For example, it may be difficult to remove or penetrate the seal to access an interior of the battery pack housing and battery packs therein. As a result, many existing battery packs cannot be serviced in a feasible manner. It may also be difficult to reapply the seal after service. For example, the seal is traditionally applied directly to both the tray and the cover. Opposing surfaces of a metal stamped tray and cover may be uneven (and thus have large profile variations), which may make application of the seal uneven. Existing seals are also not protected from, for example, gases released by battery packs during a thermal event.

The present disclosure provides for an enhanced interface between the tray and the cover of the battery pack housing. The interface includes a metal plate welded to the tray, which provides a generally smooth and regular surface for cooperation with a seal of the cover. The seal may be press-fit into a receptacle of the cover and pressed against the metal plate, or the seal may be secured in any other suitable manner. Any suitable compression based sealing system may be used. The seal may be separated from the plate during servicing (and the cover may be lifted off of the tray) without unduly disturbing the integrity of the seal and surrounding components. The metal plate includes a deflector along an inner perimeter thereof. The deflector protects the seal from gases and other contaminants that may be released from the battery pack, such as during a thermal event.

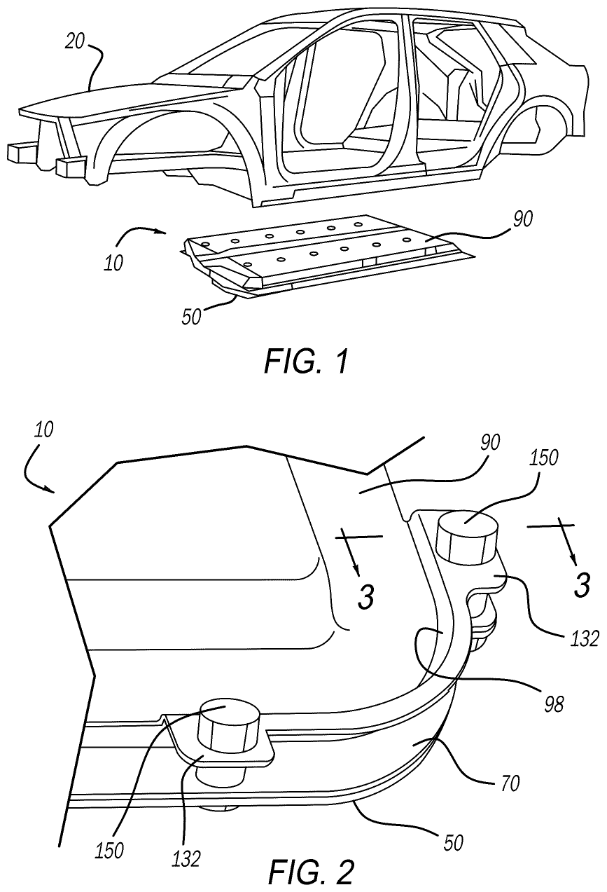

FIG. 1 illustrates an exemplary battery pack housing 10 in accordance with the present disclosure. The battery pack housing 10 is configured to house therein any suitable number and type of battery packs. For example, electric vehicle battery packs for any suitable vehicle 20 may be sealed within the battery pack housing 10. The battery pack housing 10 may be configured for use with any suitable non-vehicular application as well.

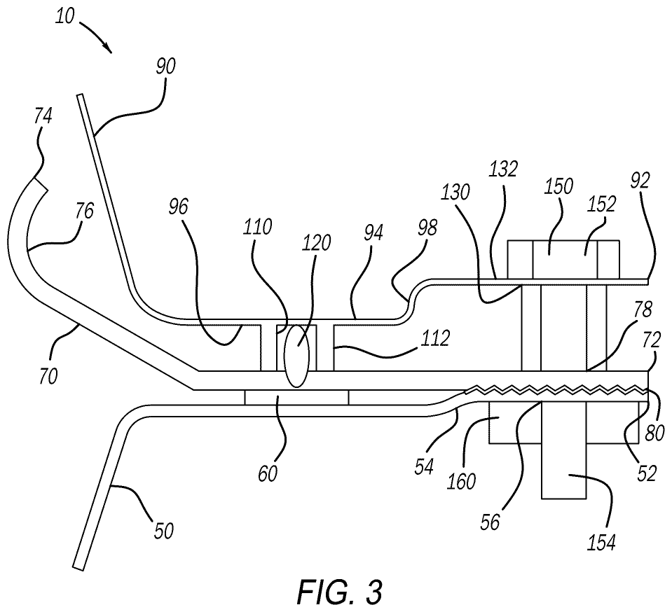

With continued reference to FIG. 1, and additional reference to FIGS. 2 and 3, the exemplary battery pack housing 10 will now be described in detail. The battery pack housing 10 generally includes a tray 50 and a cover 90. The tray 50 may be made of any suitable material, such as any suitable metallic material. The tray 50 may be metal stamped, for example. The cover 90 may be made of any suitable material, such as any suitable composite material.

The tray 50 is sized and shaped to accommodate any suitable number of battery packs thereon. The tray 50 includes an outer tray perimeter 52, which extends around an outer edge and outer area of the tray 50. The outer tray perimeter 52 is also at an outer perimeter of the battery pack housing 10. A tray stepped surface 54 is inboard of the outer tray perimeter 52. At the tray stepped surface 54, the tray 50 bends upwards towards the cover 90 such that the outer tray perimeter 52 is closer to the cover 90 than an inner area of the tray 50.

A deflector plate 70 is between the tray 50 and the cover 90. The deflector plate 70 may be made of any suitable material, such as any suitable metallic material. The deflector plate 70 has a generally smooth outer surface. The deflector plate 70 extends around the battery pack housing 10 at the outer perimeter of the battery pack housing 10. The deflector plate 70 may extend continuously around the outer perimeter of the battery pack housing 10, or discontinuously.

The deflector plate 70 includes an outer end 72 and an inner end 74. The outer end 72 is opposite to the outer tray perimeter 52 of the tray 50. The deflector plate 70 is mounted to the tray 50 at the outer tray perimeter 52 and slightly inboard thereof. The deflector plate 70 is mounted to the tray 50 in any suitable manner, such as with a weld 80.

The deflector plate 70 further includes a flange, which in the example illustrated provides a curved surface 76. The flange need not be curved, however. The curved surface 76 is at or proximate to the inner end 74. The curved surface 76 is curved upward towards the cover 90 to protect an interface area between the tray 50 and the cover 90. For example, the curved surface 76 protects a seal 120 from contaminants, such as gas and other contaminants that may be released from batteries within the battery pack housing 10 during a thermal event. The curved surface 76 effectively blocks gas and other contaminates from passing across the deflector plate 70 to the seal 120.

Between the deflector plate 70 and the tray 50 is a damper 60. The damper 60 may be made of any suitable material, such as any suitable foam material. The damper 60 is configured to dampen noise, vibration, and harshness between the deflector plate 70 and the tray 50. The damper 60 is also configured to provide a seal between the deflector plate 70 and the tray 50. The damper 60 may be arranged opposite to the seal 120, for example.

The cover 90 includes an outer end 92. Proximate to the outer end 92 is a cover stepped surface 98. The cover stepped surface 98 extends along an outer perimeter of the cover 90 and the outer perimeter of the battery pack housing 10. The cover stepped surface 98 is generally s-shaped in cross-section. At the cover stepped surface 98, the cover 90 bends outward and away from the deflector plate 70. The cover stepped surface 98 generally increases the strength of a flange 132 of the cover 90, which is described further herein.

The cover 90 further includes an outer surface 94, which is opposite to an inner surface 96. The inner surface 96 faces the deflector plate 70. At the inner surface 96 is a receptacle 110, which may be defined in any suitable manner, such as by projections 112. Any suitable compression-based sealing system may be used. For example, the seal 120 may be seated within the receptacle 110. The seal 120 extends around the outer perimeter of the battery pack housing 10. The seal 120 is press-fit into the receptacle 110 and seals against the deflector plate 70. The seal 120 may be made of any suitable material, such as any suitable elastomeric material. Any other suitable compression sealing system may be used in place of, or in addition to, the seal 120. Also, the seal 120 may be secured in place in any suitable manner other than being press-fit into the receptacle 110.

The cover 90 is mounted to the tray 50 with any suitable fastener, such as the fastener 150. The fastener 150 includes a head 152 and a shaft 154 extending from the head 152. A nut 160 is threaded onto the shaft 154. The fastener 150 is inserted through a cover aperture 130 defined by the cover 90, and particularly a flange 132 of the cover 90. The fastener 150 is further inserted through a deflector plate aperture 78 of the deflector plate 70, and through a tray aperture 56 of the tray 50. In the example illustrated, the head 152 abuts the outer surface 94 of the cover 90 at the flange 132, and the nut 160 abuts an outer surface of the tray 50. Any suitable number of fasteners 150 may be included around the outer perimeter of the battery pack housing 10.

The fastener 150 secures the cover 90 and the tray 50 together, with the deflector plate 70 therebetween. Tightening the fastener 150 presses the seal 120 against the deflector plate 70. The seal 120 prevents contaminants from entering the battery pack housing 12, and prevents gas from exiting the battery pack housing 12, such as during a thermal event. The deflector plate 70 provides a smooth metal surface for the seal 120 to seal against. To open the battery pack housing 12, such as for servicing, the fastener 150 is removed from cooperation with the deflector plate 70 and the tray 50, which allows the cover 90 and the seal 120 to be lifted off of the deflector plate 70 and the tray 50. The deflector plate 70 will remain secured to the tray 50 by way of the weld 80. The seal 120 will remain press-fit into the receptacle 110. After servicing is complete, the cover 90 is placed back onto the deflector plate 70 and the tray 50. The fastener 150 is tightened again, which compresses the seal 120 against the deflector plate 70. The tray stepped surface 54 and the cover stepped surface 98 enhance the pressure applied by the fastener 150 to the tray 50 and the cover 90 to hold the tray 50 and the cover 90 together, as well as press the seal 120 against the deflector plate 70. The curved surface 76 at the inner end of the deflector plate 70 protects the seal 120 from any contaminants that may be released from the batteries, such as during a thermal event.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery pack housing comprising:
a tray including an outer tray perimeter;
a deflector plate mounted to the tray along the outer tray perimeter;
a cover; and
a seal between the cover and the deflector plate,
wherein the cover is mounted over the deflector plate and the tray such that the deflector plate is between the tray and the cover, and the seal is pressed against the deflector plate.

2. The battery pack housing of claim 1, wherein the deflector plate is welded to the tray.

3. The battery pack housing of claim 1, further comprising foam between the deflector plate and the tray, the foam configured to dampen noise and vibrations.

4. The battery pack housing of claim 3, wherein the foam is opposite to the seal.

5. The battery pack housing of claim 1, wherein the seal is in cooperation with the cover.

6. The battery pack housing of claim 1, wherein the tray is metallic and the cover is made of a composite material.

7. The battery pack housing of claim 1, further comprising a fastener in cooperation with the tray, the deflector plate, and the cover.

8. The battery pack housing of claim 7, wherein:
the cover defines an aperture through which the fastener extends, the aperture is vertically offset from the seal; and
the cover includes a stepped surface between the seal and the aperture.

9. The battery pack housing of claim 1, wherein the deflector plate includes a curved surface at an inner end thereof extending towards the cover.

10. The battery pack housing of claim 9, wherein the curved surface is configured to provide a barrier between the seal and emissions released from a battery within the battery pack housing during a thermal event.

11. A battery pack housing comprising:
a tray including an outer tray perimeter;
a deflector plate mounted to the tray along the outer tray perimeter, the deflector plate including a flange at an inner end of the deflector plate, the flange extending away from the tray;
a cover defining a receptacle at an inner surface of the cover, the receptacle extending about an outer cover perimeter of the cover; and
a seal that is press-fit into the receptacle and pressed against the deflector plate,
wherein the cover is mounted over the deflector plate and the tray such that the deflector plate is between the tray and the cover, the flange of the deflector plate extends towards the cover, and the flange provides a barrier between an interior of the battery pack housing and the seal.

12. The battery pack housing of claim 11, wherein the deflector plate is welded to the tray.

13. The battery pack housing of claim 11, further comprising foam between the deflector plate and the tray, the foam configured to dampen noise and vibrations.

14. The battery pack housing of claim 13, wherein the foam is opposite to the seal.

15. The battery pack housing of claim 11, wherein the flange is curved towards the cover.

16. The battery pack housing of claim 11, further comprising a fastener in cooperation with the tray, the deflector plate, and the cover.

17. The battery pack housing of claim 16, wherein:
the cover defines an aperture through which the fastener extends, the aperture is vertically offset from the receptacle; and
the cover includes a stepped surface between the aperture and the receptacle.

18. A battery pack housing comprising:
a tray including an outer tray perimeter;
a deflector plate welded to the tray along the outer tray perimeter, the deflector plate including a curved surface at an inner end of the deflector plate, the curved surface extending away from the tray;
a vibration damper between the deflector plate and the tray;
a cover defining a receptacle at an inner surface of the cover, the receptacle extending about an outer cover perimeter of the cover;
a seal that is press-fit into the receptacle and pressed against the deflector plate; and
a fastener extending through the tray, the deflector plate, and the cover to connect the cover to the tray with the deflector plate between the cover and the tray, and to press the seal against the deflector plate,
wherein the curved surface of the deflector plate extends towards the cover and provides a barrier between an interior of the battery pack housing and the seal.

19. The battery pack housing of claim 18, wherein the vibration damper is opposite to the seal.

20. The battery pack housing of claim 18, wherein the cover is spaced apart from the deflector plate and the tray.
